(19) United States
(12) Patent Application Publication
(10) Pub. No.: US 2022/0284200 A1
(43) Pub. Date: Sep. 8, 2022

(54) METHOD OF EXTENDING A RFID TAG READING RANGE AND DEVICE FOR CARRYING OUT THE SAME

(71) Applicant: Alexandr Gennadievich KONDRATIEV, Moscow (RU)

(72) Inventors: Alexandr Gennadievich KONDRATIEV, Moscow (RU); Sergey Vilenovich DROZDOV, Moscow (RU); Alexandr Evgenievich MARKIN, Moscow (RU); Aram Vitalievich PANKOV, Moscow (RU); Dmitry Vladimirovich ZHUKOV, Moscow (RU)

(73) Assignee: Alexandr Gennadievich KONDRATIEV, Moscow (RU)

(21) Appl. No.: 17/637,247

(22) PCT Filed: May 7, 2020
(86) PCT No.: PCT/RU2020/000214

§ 371 Date: Feb. 22, 2022

(30) Foreign Application Priority Data
Aug. 19, 2019 (RU) 2019118120

(51) Int. Cl. G06K 7/10

(52) U.S. Cl. CPC G06K 7/10366

(57) ABSTRACT

A method of increasing a RFID tag reading range and a device for carrying out the same, said method comprising placing the RFID tag in an electrically polarizable medium, which may be water or another polarizable liquid or a polarizable amorphous plastic or melt. The device comprises a capsule into which the RFID tag is mounted. Then, the capsule is filled with an electrically polarizable medium.

The invention relates to the production and use of radio frequency identification (RFID) tags with information recorded and stored thereon for subsequent reading.

RFID tags are widely used in various fields, in particular for labeling goods during transportation, in the automation of production processes, in logistics, payment systems, personnel identification, security systems, medicine, trade and other fields.

RFID tags are classified according to the following criteria:

1) power supply:
active RFID tags with a self-contained power supply and a wide reading range, large sized, highly priced and not very easy-to-use;
passive RFID tags with an independent power supply, a narrower reading range, smaller sizes and a limited operating time dependent on the battery charging.
passive RFID tags without a power supply, excitable by a scanning electromagnetic wave, with a still narrower reading range, small sizes, easy-to-use and having a long operating life.

2) operating frequency band:
LF band presents problems with long-distance reading and interference problems,
like LF band, HF band presents problems with long-distance reading under high humidity conditions and in the presence of metal, interference may also occur while reading,
UHF band presents no interference problems, reading under high humidity conditions is possible but costly related equipment, scanners and antennas are required;

3) memory type being used:
RO wherein data is recorded only once when manufactured and is suitable only for reading,
WORM wherein tags contain a unique identifier and a repeatedly readable write-once memory unit,
RW wherein tags contain an identifier and a memory unit for data reading and recording, and wherein data can be rerecorded repeatedly;

4) design:
encased RFID tags, RFID labels, RFID cards, RFID blips and other designs.

The present invention is intended to increase the reading range of RFID tags, in particular passive tags having no own self-contained power supply and operating due to the energy of the scanning electromagnetic field.

A RFID tag comprises an electronic memory unit configured as an electronic circuit for storing and processing information, and a built-in antenna for receiving and transmitting a signal.

Tags operate in combination with scanning devices which generate continuous electromagnetic waves at a specific frequency.

A tag is attached to items or objects to be accounted or tracked and can be read by a scanning device within a reading zone the radius of which can reach several meters.

When a tag is detected within the reading zone of the scanning device, its signal is modulated and the resulting electromagnetic response of the tag is read by the scanning device able not only to generate electromagnetic waves but also to receive the same.

The principle of operation of the RFID tag is as follows.

The built-in RFID tag antenna excited by a sinusoidal electromagnetic wave of the scanning device begins to emit a reflected backward wave modulated by the RFID tag at the same frequency as the scanning device carrier frequency. A part of the energy of the scanning electromagnetic field received by the RFID tag is transmitted to a chip of the RFID tag electronic memory unit, which reads information from its memory and modulates the electromagnetic wave reflected by the RFID tag receiving antenna by low frequency, as compared to the scanning device carrier frequency, oscillations encoding the information having been read. This modulated reflected wave with information is further received and processed by the scanning device.

Thus, the RFID tag has to receive a sufficient amount of electromagnetic energy from the scanning device so that it will suffice to excite the reflected carrier frequency electromagnetic wave, to power the chip to read information encoded in the RFID tag memory unit and to modulate the reflected wave.

Unlike tags with their own power supplies, passive RFID tags require more powerful scanning devices so that the reflected modulated signal can be generated, on the one hand, and can be read by the scanning device, on the other hand. The distance at which the scanning device can receive the signal reflected by the RFID tag is called the reading range.

The reading range of the RFID tag has to be maximized for increasing its effectiveness.

Various methods are known for increasing the reading range, namely:
to enhance performance of the scanning device, which makes the scanning device more costly and bulky,
to develop a less energy-intensive tag chip, which is a difficult engineering task. In this case, the energy taken from the antenna by the RFID tag chip diminishes and the intrinsic emission of this antenna becomes stronger,
to develop a more efficient RFID tag antenna to receive more energy from the electromagnetic wave of the scanning device. However, the need for compact tags and their antennas makes this method a difficult engineering task.

The most serious problems with the tag reading range occur when the RFID tag has to be mounted on a metal object. Since electromagnetic waves are strongly absorbed by metals, even tags specially designed for such cases are not always able to provide the desired result.

The claimed invention relates to a method of increasing the reading range of a passive-type RFID tag having no own power supply and operating due to the energy of the scanning electromagnetic field, and to a device for carrying out this method.

It is an object of the invention to increase the range of reading a passive RFID tag by a scanning device.

The present invention proposes a fundamentally new method of increasing the reading range of a passive RFID tag.

The effectiveness of this method was confirmed experimentally for passive RFID tags in the UHF band and a similar effect applies to the LF and HF bands.

The proposed method comprises placing a RFID tag in water or another medium having an electrically polar molecular structure. When the RFID tag is placed in water, viscous fluid or amorphous plastic or melt having an electrically polar molecular structure, its reading range unexpectedly increases several times.

A polarizable medium is poured into a capsule.

The capsule shell has to be made of a dielectric material such as plastic, epoxy resin, rubber and glass.

The capsule sizes may vary from those practically coinciding with the size of the RFID tag itself to the one several times exceeding the size of the RFID tag.

The capsule shape is inessential and may be chosen for reasons of mating the same conveniently with the structures on which the RFID tag is placed. In the tests, various forms of RFID tags were used, such as tablets, parallelepipeds, ellipsoids and spheres.

The reading range extension coefficient varies from 3-5 to 30-50 times.

Passive RFID tags available from GAO (Canada), operating in the UHF range of 860-960 MHz, having a linearly polarized built-in antenna and protected by a dielectric material were used in the tests. The tags are provided with an Alien H3 chip. The tags are configured as a bolt.

An electromagnetic signal is generated by the scanning device with a circularly polarized directional antenna operating in the same frequency range of 860-960 MHz as the RFID tag antenna. The same scanning device reads the tag response using the software installed thereon.

While the reading range of up to 2 meters is claimed by the manufacturer, the real range showed experimentally does not exceed 5 cm.

When testing, the RFID tag was placed in water. In so doing, the reading range unexpectedly increased to one and a half meters.

Similar experimental results were obtained when RFID tags were immersed in other liquids such as alcohols, saline solutions, sugar solutions and epoxy melts with conductive additives. The reading range of RFID tags increased several times.

During experiments, RFID tags available from different manufacturers and having different designs were used, such as labels, blips, bolts and nuts. A similar effect of extending the reading range was observed for all tags when placed in a capsule with an electrically polarizable medium.

Such effect physically accounts for by the fact that all media where it is observed, like water, are formed by molecules comprising rigidly defined microscopic electric dipoles similarly to the RFID tag receiving antenna also comprising an electric dipole from the physical point of view.

In the absence of a sinusoidal electromagnetic wave of the scanning device electromagnetic field, multidirectional microscopic dipoles of the polar medium in the capsule surrounding the RFID tag are formed due to thermal motion and the average polarization of the capsule medium used with the RFID tag inside the same is zero. Arrival of a sinusoidal wave of the scanning device electromagnetic field not only excites the RFID tag antenna comprising the main electric dipole in this case but also aligns the medium molecules along the scanning wave.

The electromagnetic field of the scanning device is quasi-stationary for RFID tags of typical sizes and for physical properties of the substances used to fill the capsule. A characteristic relaxation time of water molecules and similar polarizable media for the UHF band is shorter than the scanning electromagnetic wave period. The quasi-stationary state conditions of the field are also met for LF and HF bands. In this situation, microscopic dipoles which succeed to become aligned along the scanning sinusoidal electromagnetic wave begin to oscillate in unison with the total dipole of the RFID tag antenna itself. There is a resonant response amplification which leads to a sharp increase in the RFID tag reading range.

The experiments show that just a small, in terms of the RFID tag size and design, amount of water or other polarizable medium is enough for a pronounced effect of the RFID tag enhanced response to be observed. Even a small piece of paper wetted with water and pressed against the RFID tag causes a multiple increase in the reading range. Therefore, the capsule into which the RFID tag has to be placed only slightly increases the structure size, which is justified by a multiple increase in the reading range.

The capsule shell is made of a light and plastic dielectric material. The RFID tag in such capsule is mounted on items to be accounted taking the same protection measures as in case of the RFID tag without a capsule. In so doing, the temperature range in which such tag will be used should be appreciated with allowance for thermal compression and expansion effects of the polarizable medium used in the capsule, as well as possible liquid-gas or liquid-solid phase transitions. The material from which the capsule is made has to retain its physical properties in a wide temperature range. This range should include the melting and boiling points of the polarizable medium filling the capsule.

The following is a description of the attached drawings.

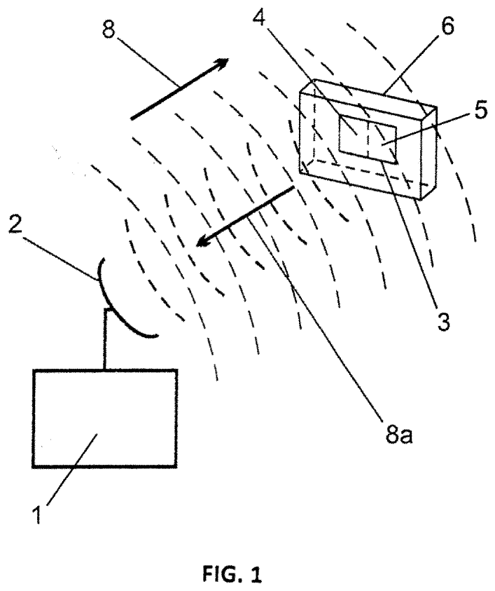

FIG. 1 is a general view of a device, where
1—scanning device,
2—scanning device antenna,
3—RFID tag,
4—RFID tag built-in receiving antenna,
5—RFID tags electronic unit,
6—capsule with a polarizable medium,
8—scanning sinusoidal electromagnetic wave,
8a—backward electromagnetic wave modulated by the RFID tag.

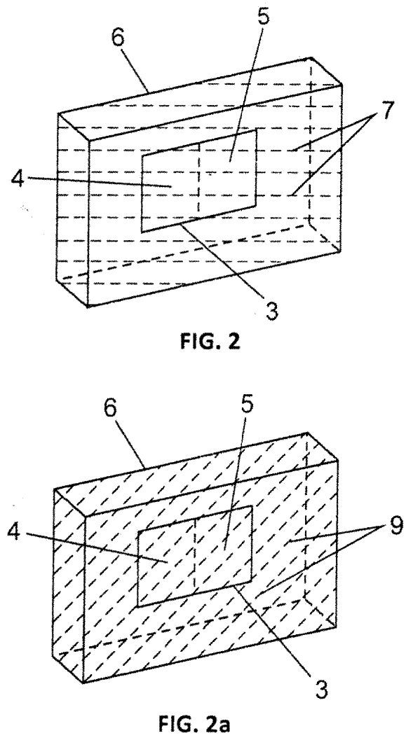

FIG. 2 is a general view of a capsule with a RFID tag, where
1—RFID tag,
4—RFID tag built-in receiving antenna,
5—RFID tags electronic unit,
6—capsule with a polarizable medium,
7—water as a polarizable medium.

FIG. 2a is a general view of a capsule with a RFID tag, where
3—RFID tag,
4—RFID tag built-in receiving antenna,
5—RFID tags electronic unit,
6—capsule with a polarizable medium,
9—viscous fluid or melt as a polarizable medium.

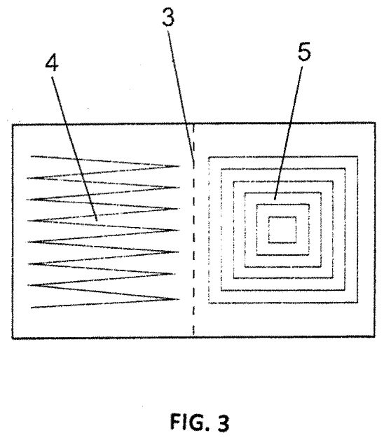

FIG. 3 is a general view of a RFID tag, where
3—RFID tag,
4—RFID tag built-in receiving antenna,
5—RFID tags electronic unit.

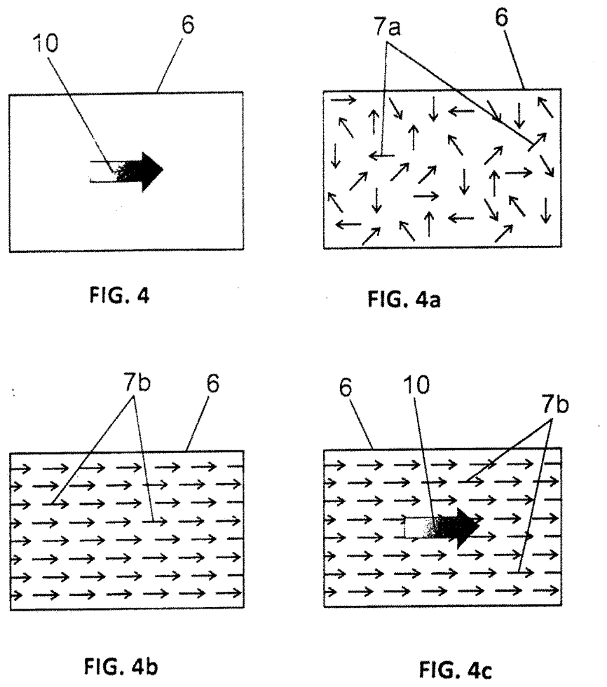

FIG. 4 is a general view of a capsule with polarizable medium, where
6—capsule with a polarizable medium,
10—electric dipole modulating a RFID tag built-in antenna.

FIG. 4a is a general view of a capsule with water molecules, where
6—capsule with a polarizable medium,
7a—water molecules in a capsule without electromagnetic field.

FIG. 4b is a general view of a capsule with water molecules, where
6—capsule,
7 b—water molecules in a capsule with electromagnetic field.

FIG. 4c is a general view of a capsule with water molecules, where
6—capsule,
7b—water molecules in a capsule with electromagnetic field,
10—electric dipole modulating a RFID tag built-in antenna.

An embodiment of the invention is described below with reference to the attached drawings.

The proposed method comprises placing a RFID tag 3 (FIG. 1, FIG. 2, FIG. 2a) in water 7 (FIG. 2), viscous liquid, amorphous plastic 9 (FIG. 2a) or melt with an electrically polar molecular structure.

Water 7 (FIG. 2) or viscous liquid, amorphous plastic 9 (FIG. 2a) or melt are placed in a capsule 6 (FIG. 1, FIG. 2, FIG. 2a) with the RFID tag 3 (FIG. 1, FIG. 2, FIG. 2a, FIG. 3).

The RFID tag 3 (FIG. 1, FIG. 2, FIG. 2a) is attached to items or objects to be accounted or tracked.

When tags 3 (FIG. 1, FIG. 2, FIG. 2a) are detected within the reading zone of a scanning device 1 (FIG. 1), a signal of the scanning device 1 (FIG. 1) is modulated and a resulting electromagnetic response of the RFID tag 3 (FIG. 1, FIG. 2, FIG. 2a) is read by the scanning device 1 (FIG. 1) able not only to generate electromagnetic waves but also to receive the same.

An electromagnetic signal is generated by the scanning device 1 (FIG. 1) with a circularly polarized directional antenna 2 (FIG. 1) in the same frequency range as that of a built-in receiving antenna 4 (FIG. 1, FIG. 2, FIG. 2a, FIG. 3) of the RFID tag 3 (FIG. 1, FIG. 2, FIG. 2a, FIG. 3).

The receiving antenna 4 (FIG. 1, FIG. 2, FIG. 2a, FIG. 3) of the RFID tag 3 (FIG. 1, FIG. 2, FIG. 2a) excited by a sinusoidal electromagnetic wave 8 (FIG. 1) of the scanning device 1 (FIG. 1) begins to emit a reflected wave 8a (FIG. 8a) at the same frequency as the scanning device 1 (FIG. 1) carrier frequency.

The sinusoidal electromagnetic wave 8 (FIG. 1) of the scanning device 1 (FIG. 1) not only excites the antenna 4 (FIG. 1, FIG. 2, FIG. 2a, FIG. 3) of the FRID tag 3 (FIG. 1, FIG. 2, FIG. 2a, FIG. 3) comprising herein physically the main electric dipole 10 (FIG. 4) but also aligns the electric dipole molecules of the polarizable medium 7a, 7b (FIG. 4a, FIG. 4b, FIG. 4c) along the scanning sinusoidal electromagnetic wave 8 (FIG. 1).

The energy of the electromagnetic field of the scanning device 1 (FIG. 1) received by the RFID tag 3 (FIG. 1, FIG. 2, FIG. 2a, FIG. 3) is transmitted to a electronic unit 5 (FIG. 1, FIG. 2, FIG. 2a, FIG. 3) chip with the RFID tag 3 memory (FIG. 1, FIG. 2, FIG. 2a, FIG. 3), which reads information from its memory and modulates a backward electromagnetic wave 8a (FIG. 1) reflected by the built-in receiving antenna 4 (FIG. 1, FIG. 2, FIG. 2a, FIG. 3) of the RFID tag 3 (FIG. 1, FIG. 2, FIG. 2a, FIG. 3) by low frequency, as compared to the scanning device carrier frequency 1 (FIG. 1), oscillations encoding the information having been read. The modulated reflected wave 8a (FIG. 1) with information is received and processed by the scanning device 1 (FIG. 1). In this case, there is observed a multiple increase in the reading range of information from the RFID tag 3 (FIG. 1, FIG. 2, FIG. 2a, FIG. 3) by the scanning device 1 (FIG. 1).

1. A method of extending a RFID tag reading range, characterized in that a RFID tag is placed in an electrically polarizable medium.

2. The method according to claim 1, characterized in that said polarizable medium is water.

3. The method according to claim 1, characterized in that said polarizable medium is a liquid or amorphous plastic or melt.

4. A device for extending a RFID tag reading range comprising a scanning device and a FRID tag, characterized in that a RFID tag is placed in a capsule filled with an electrically polarizable medium.

5. The device according to claim 4, characterized in that said polarizable medium is water.

6. The device according to claim 4, characterized in that said polarizable medium is a liquid or amorphous plastic or melt.

7. The device according to claim 4, characterized in that said capsule is made of a dielectric material.
